(19) United States
(12) Patent Application Publication
(10) Pub. No.: US 2018/0089695 A1
(43) Pub. Date: Mar. 29, 2018

(54) The algorithm : a method for discovering securities fraud networks in transaction data

(71) Applicant: Bradley MacDowell Voorhees, Severna Park, MD (US)

(72) Inventor: Bradley MacDowell Voorhees, Severna Park, MD (US)

(21) Appl. No.: 15/330,481

(22) Filed: Sep. 27, 2016

(51) Int. Cl. G06Q 30/00

(52) U.S. Cl. CPC G06Q 30/0185

(57) ABSTRACT

The Algorithm is an iterative method for detecting fraud networks in transaction data beginning with either a known fraud window on a specific security, or a known trader. The Algorithm begins by “Blue Sheeting” either every transaction in the fraud window on a known security with a view toward discovering all currently unknown traders making only profitable short term transactions (“modus operandi” transactions) on the known security during the known window, or “Blue Sheeting” every transaction placed by a known trader with a view toward identifying the trader's “modus operandi” transactions on currently unknown securities which will be regarded as the next iteration's security-specific-fraud-windows-of-time. By iteratively “Blue Sheeting” to discover “modus operandi” trade orders and the traders responsible, and then “Blue Sheeting” security-specific-fraud-windows-of-time (circumscribed by “modus operandi” transactions revealed in the immediately previous step above), and traders transacting in those windows, followed by another iteration of “Blue Sheeting” to discover those traders' past “modus operandi” transactions to discover new security-specific-fraud-windows-of-time, the entire network history of manipulated securities and market actors is iteratively discovered. Having solved for all the security-specific fraud windows, if a high correlation exists between the timing of the same transacting parties, making the same “modus operandi” transactions, on all the same securities, in those security-specific-fraud-windows, the whole insider-trading network is revealed. This correlation alone proves the criminal intent of the network to a mathematical certainty because of the sheer impossibility that multiple parties would randomly-coincidently make all the same, profitable, trading orders on all the same securities at all the same times with all the same results, over an extended period of time—leaving room for only one conclusion: that the synchronization of the trades is a deliberate scheme. The bounds of the criminal network are known and the whole insider-trading network is completely revealed when the reiteration of The Algorithm yields only all the same parties, placing all the same “modus operandi” transactions independently on all the same securities, in all the same specific-windows-of-time.

### STATEMENT REGARDING FEDERALLY SPONSORED RESEARCH OR DEVELOPMENT

The inventor of record visualized the claimed algorithm after attending a training event on, Nov. 12, 2015, at the headquarters of the US Securities and Exchange Commission, led by the Acting Deputy Commissioner of Patent Innovation and the Director of Inventor Outreach, Education, and Recognition.

### CROSS-REFERENCE TO RELATED APPLICATIONS

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

This method for discovering securities fraud networks in transaction data was originally conceived to reveal fraud networks that leverage the patent system whereby unscrupulous patent practitioners file frivolous inter partes review (IPR) challenges against new patents published in the USPTO Gazette, held by publicly traded companies, to cause a negative market reaction that would create an opportunity for unscrupulous traders to short sell shares of said publicly traded companies.

So the problem of discerning the described market manipulation network becomes a question of how does one link a unscrupulous patent practitioner filing a frivolous lawsuit against a new patent, to unscrupulous market actors who capitalize on the negative market reaction by shorting the stock of the publicly traded company holding the newly minted patent.

A Put-Derivative is a contract hedging option that, for a short time and set fee based on risk, a trader can buy the right to sell a security at an agreed upon price to another party. Therefore, if a share of stock is trading at $10, and a trader buys a million Put-Derivatives from a hedge fund for the option to sell the hedge fund a million shares of the stock at $10 each, if the price of the shares drops to $7 in the market, (incident to news of a recently filed patent litigation), the million option contracts held by the trader (giving them the right to sell the hedge fund a million shares at $10 each) just became worth $3M to the trader, able to buy a million shares at the market rate for $7 a share and sell for $10 each.

Transaction data, often referred to Blue Sheet Data, is available from brokerages, exchanges, and market makers. Blue Sheet Data details every transaction and every party to those transactions, in the market, over a specific security, during a specific time.

A two variable (practitioner and trader) equation requires two independent expressions to solve. The answer is time (a fraud window) and position (the security). There is a narrow security-specific fraud window, only during which time, the unscrupulous trader can profit. The fraud window opens when the USPTO Gazette containing the targeted patent is published, and the window closes shortly after the news of the patent challenge hits the market via newswire causing the market reaction. The unscrupulous patent practitioner must file the frivolous IPR to cause the market reaction necessary to close the window and make transactions placed by the unscrupulous trader profitable. Therefore, the unscrupulous trader can only know which publicly traded company to purchase Put-Derivatives after the USPTO Gazette is published and must exercise the options after the market reacts to the news of the IPR.

The Algorithm begins with either a known fraud window on a specific security, (e.g. the stock of the publicly traded company from the time of the Patent Gazette's publication identifying the patent, to the time of the market reaction to the news of the IPR), or a known trader. The Algorithm begins by Blue Sheeting either every transaction in the fraud window on a known security with a view toward discovering all currently unknown traders buying and exercising Put-Derivatives on the known security during the known window, or Blue Sheeting every transaction placed by a known trader with a view toward identifying the trader's Put-Derivative purchases and exercises on currently unknown securities which will be regarded as the next iteration's security-specific fraud windows. By iteratively Blue Sheeting traders and security-specific windows, and traders transacting in those windows, and then those traders' transactions to discover the new security-specific fraud windows, the entire network history of manipulated securities and market actors is revealed. Having solved for the security-specific fraud windows, if the publication of PTO Gazettes containing patents held by public companies correlate with the security-specific fraud windows, the patent practitioners filing those patents can be identified from the IPR filings with the PTO. If a high correlation between the timing of the practitioners' filing those IPRs, and the security-specific fraud windows exists, the unscrupulous patent practitioners are revealed. If a high correlation exists between the timing of Put-Derivative-purchases-and-exercises (modus operandi transactions) of several traders, during the exact same windows on the same securities, on multiple occasions, then the unscrupulous traders are revealed.

The key to The Algorithm is the iterative oscillation between Blue Sheeting every transaction in a security-specific fraud window, from these transactions, identifying previously unknown traders whose transactions fit the Put-Derivative-purchase-and-exercise “modus operandi” in a known window, and then Blue Sheeting every transaction by those traders to discover previously unknown similar transactions on different securities to identify the new, previously unknown security-specific fraud windows. The Algorithm is repeatable until all the security-specific fraud windows and traders in those windows are discovered.

The Algorithm works the same for good news in the market that causes the manipulated security price to rise. In this case, the transaction modus operandi in the fraud window would be a purchase of shares and sale, or a purchase of Call-Derivatives whereby the trader buys the right to buy shares in the future at a fixed price, which would therefore make the Call-Derivatives valuable. Therefore, if a trader purchases a million Call-Derivatives (or options) for a risk based fee, for the right to buy shares for $7 each, and the market price rises to $10 during the life of the options, the options would be worth $3M because the trader could buy shares from the option seller at $7 each and sell them on the open market for $10 a share. Alternatively, the trader could buy shares at an initial price and when the good news hit the market, sell the shares at the newly inflated price.

### (1) Field of the Invention

The field of the invention is market and transaction analysis; a method for discovering securities fraud networks in transaction data.

### (2) Description of Related Art

References:

None

### BRIEF SUMMARY OF THE INVENTION

The Algorithm is a method for detecting securities fraud networks in transaction data that begins with either a suspected fraud-window-of-time on a specific security, or a suspected trader.

The Algorithm begins by “Blue Sheeting” (requesting transaction data from the Financial Industry Regulatory Authority (FINRA)) either every transaction in the fraud window on a known security with a view toward discovering all currently unknown traders making profitable short term “modus operandi” transactions on the known security during the known window, or “Blue Sheeting” every transaction placed by a known trader with a view toward identifying the trader's short-term only profitable “modus operandi” transactions on currently unknown securities which will be regarded as the next iteration's security-specific fraud windows. By iteratively “Blue Sheeting” traders and security-specific windows, and traders transacting in those windows, and then those traders' past transactions to discover the new security-specific fraud windows, the entire network history of manipulated securities and market actors is revealed. Having solved for the security-specific fraud windows, if a high correlation exists between the timing of the same transacting parties, making the same “modus operandi” transactions, on all the same securities, in those security-specific-fraud-windows, the whole insider-trading network is revealed. The bounds of the criminal network are known and the whole insider-trading network is completely revealed when the reiteration of The Algorithm yields only all the same parties, placing all the same “modus operandi” transactions independently on all the same securities, in all the same specific-windows-of-time.

The key to The Algorithm is the iterative oscillation between “Blue Sheeting” every transaction in a security-specific fraud window, from these transactions, identifying previously unknown traders whose transactions fit the transaction “modus operandi,” and then “Blue Sheeting” every transaction by those traders to discover previously unknown similar transactions on different securities which define the new, previously unknown security-specific-fraud-windows-of-time—and then repeating the Algorithm over the new, previously unknown security-specific-fraud-windows-of-time. The Algorithm is infinitely repeatable until all the security-specific-fraud-windows-of-time and traders in those windows are discovered.

### BRIEF DESCRIPTION OF THE SEVERAL VIEWS OF THE DRAWING(S)

Not Applicable.

### DETAILED DESCRIPTION OF THE INVENTION

### (1) Summary of Invention and Advantages

The Algorithm is an iterative method for detecting securities fraud networks in transaction data that begins with either a suspected fraud window on a specific security, or a suspected trader.

The Algorithm begins by “Blue Sheeting” either every transaction in the fraud window on a known security with a view toward discovering all currently unknown traders making only profitable short term transactions (“modus operandi” transactions) on the known security during the known window, or “Blue Sheeting” every transaction placed by a known trader with a view toward identifying the trader's “modus operandi” transactions on currently unknown securities which will be regarded as the next iteration's security-specific-fraud-windows-of-time. By iteratively “Blue Sheeting” traders and security-specific-fraud-windows, and traders transacting in those windows, and then those traders' past “modus operandi” transactions to discover new security-specific-fraud-windows-of-time, the entire network history of manipulated securities and market actors is revealed. Having solved for the security-specific fraud windows, if a high correlation exists between the timing of the same transacting parties, making the same “modus operandi” transactions, on all the same securities, in those security-specific-fraud-windows, the whole insider-trading network is revealed. This correlation alone proves the criminal intent of the network to a mathematical certainty because of the sheer impossibility that multiple parties would randomly-coincidently make all the same, highly profitable, trading orders on all the same securities at all the same times with all the same results, over an extended period of time—leaving room for only one conclusion: that the synchronization of the trades is a deliberate scheme. The bounds of the criminal network are known and the whole insider-trading network is completely revealed when the reiteration of The Algorithm yields only all the same parties, placing all the same “modus operandi” transactions independently on all the same securities, in all the same specific-windows-of-time.

The key to The Algorithm is the iterative oscillation between “Blue Sheeting” every transaction in a security-specific-fraud-window-of-time, from these “modus operandi” transactions in this security-specific-fraud-window-of-time, identifying previously unknown traders whose transactions fit the transaction modus operandi, and then “Blue Sheeting” every transaction by those traders to discover said trading parties' previously unknown similar transactions on different securities which define the new, previously unknown security-specific-fraud-windows-of-time—then The Algorithm is recycled over said previously unknown security-specific-fraud-windows-of-time. The Algorithm is infinitely recyclable until all the security-specific-fraud-windows-of-time and traders in those windows are discovered.

A distinct advantage of The Algorithm is that it reveals networks of traders and manipulators based solely on transaction data, which lends itself to real-time machine patrolling of market activity.

Another distinct advantage of the Algorithm is that it identifies all traders trading according to the same profitable modus operandi, and proves network conspiracy and intent with mathematical exactitude where a high correlation of specifically profitable transactions, across a large number of specific securities, in the exact same narrow fraud windows of time is otherwise a mathematically impossible coincidence. The complete, highly correlated network transaction history proves proves intent, conspiracy, and knowledge to a certainty with nothing more. The difficulty in proving intent and knowledge used to be a limiting factor in securities litigation cases—The Algorithm reveals knowledge and intent through the transaction data alone. This is extremely valuable for federal securities regulators and securities law enforcement litigators.

### (2) Description of Preferred Embodiments

One preferred embodiment of The Algorithm is an application arising when a specific-window-of-time on a particular security presents itself as a window of time during which criminal transactions are possible. Such a circumstance arises when a complaint or evidence surfaces of an instance of insider trading where an insider leaks information to another person about a specific security (i.e. a merger of a publicly traded company that will cause an immediate market increase in the stock price) that will shortly affect the stock price of a particular company. The specific-window-of-time during which the criminal transaction is possible, is the window of time opening at the time that the imminent merger was known to insiders and closing shortly after the news of the merger hit the market and caused the stock price to react. In this case, the “modus operandi” transaction would be a highly-profitable, large “buy” order of stock, or “buy” order of “call” options on the particular security at the beginning of the specific-window-of-time followed by a lucrative “sell” order of stock, or exercise of the “call” options at the close of the window. The next step for law enforcement or regulators is to contact the Financial Industry Regulatory Authority (FINRA) to “Blue Sheet” the transactions on that security in that specific-window-of-time, and identify all the possible “modus operandi” transactions on said security during the said specific-window-of-time. Once the “modus operandi” transactions in the specific-window-of-time are identified, the transacting parties placing those “modus operandi” orders are “Blue Sheeted,” and in the personal transaction history of those transacting parties, we look for other similar “modus operandi” transactions on other securities. Any other “modus operandi” transactions on previously unknown securities discovered in the transaction history of said transacting parties, demarcate the new specific-windows-of-time on those previously unknown securities. Those new specific-windows-of-time on those previously unknown securities become the new windows of time during which criminal transactions are possible, and The Algorithm is recycled. The Algorithm is recycled until no new specific-windows-of-time are revealed. The Algorithm exposes all the members of the insider trading network because all the same transacting parties will be placing all the same “modus operandi” transactions on all the same securities in all the same specific-windows-of-time. This correlation alone proves the criminal intent of the network to a mathematical certainty because of the sheer impossibility that multiple parties would randomly-coincidently make all the same, highly profitable, trading orders on all the same securities at all the same times with all the same results, over an extended period of time—leaves room for only one conclusion: that the synchronization of the trades is a deliberate scheme. The bounds of the criminal network are known and the whole insider-trading network is completely revealed when the reiteration of The Algorithm yields only all the same parties, placing all the same “modus operandi” transactions independently on all the same securities, in all the same specific-windows-of-time.

The second preferred embodiment of The Algorithm is an application arising when only a specific transacting party is suspected of conducting criminal transactions. Such a circumstance arises when a complaint or evidence surfaces that a particular transacting party might be part of an insider-trading network. The Algorithm can be initiated at the middle step by “Blue Sheeting” the transaction history of a transacting party, with a view toward identifying typical “modus operandi” transactions, short term, highly profitable, transactions. Any such transactions demarcate new previously unknown specific-windows-of-time on previously unknown securities, during which criminal transactions are possible. And The Algorithm is reiterated over said previously unknown specific-windows-of-time. The bounds of the criminal network are known and the whole insider-trading network is completely revealed when the reiteration of The Algorithm yields only all the same parties, placing all the same “modus operandi” transactions on all the same securities in all the same specific-windows-of-time.

I claim:

1. An iterative method for detecting securities fraud networks in transaction data comprising: identifying a specific-window-of-time during which criminal transactions on a specific-security are suspected; determine the “modus operandi” transaction types possible in said specific-window-of-time on said specific-security; “Blue Sheet” transaction data on said specific-security during said specific-window-of-time; find new-transactions in said transaction data that match said “modus operandi” transactions; identify all individual-transactors of said new-transactions; for each of said individual-transactors, “Blue Sheet” all trading-order data of historical trades placed by each of said individual-transactors; identify any similar-“modus operandi” transaction on any previously-unknown-specific-security by all of said individual-transactors in said trading-order data; for each similar-“modus operandi” transaction, set a new-specific-window-of-time on said previously-unknown-specific-security during which criminal transactions are possible, covering the timing of said similar-“modus operandi” transaction; and repeat the foregoing sequence, as a subsequent iteration, for each said new-specific-window-of-time on said previously-unknown-specific-security, by substituting said specific-window-of-time with said new-specific-window-of-time and substituting said specific-security with said previously-unknown-specific-security, until future said subsequent iterations fail to yield a subsequent new-specific-window-of-time on any subsequent previously-unknown-specific-security.

2. An iterative method for detecting securities fraud networks in transaction data as set forth in claim 1, where the initial iteration with: “Blue Sheet” all trading-order data of historical trades placed by said individual-transactors of said “modus operandi” transactions.
